(19) United States
(12) Patent Application Publication
(10) Pub. No.: US 2006/0164405 A1
(43) Pub. Date: Jul. 27, 2006

(54) Driving scheme for a bi-stable display with improved greyscale accuracy

(76) Inventor: Guofu Zhou, Best (NL)

Correspondence Address: PHILIPS INTELLECTUAL PROPERTY & STANDARDS, P.O. BOX 3001, BRIARCLIFF MANOR, NY, 10510, US

(21) Appl. No.: 10/564,308

(22) PCT Filed: Jul. 7, 2004
(86) PCT No.: PCT/IB04/51157

§ 371 Date: Jan. 10, 2006

Related U.S. Application Data
(60) Provisional application No. 60/486,699, filed on Jul. 11, 2003.
(60) Provisional application No. 60/517,354, filed on Nov. 4, 2003.

(51) Int. Cl. G09G 5/00

(52) U.S. Cl. 345/204

(57) ABSTRACT

An image is updated on a bi-stable display (310) such as an electrophoretic display by driving the display from a current optical state to a reference optical state, and then to a final optical state. The optical stated may be greyscale or color states. The reference state is selected based on the current state rather than the final state. In one possible case, a reference state is white (W) when a current state is between full black (B) when a current state is between full white (W) and middle grey (MG). In another case, the reference state may be a middle grey point (MG) for image transitions to black (B) when the A current state is between full black and middle grey (transitions 792, 794, 796, 798), or for image transitions to white (W) when the current state is between full white and middle grey.

The invention relates generally to electronic reading devices such as electronic books and electronic newspapers and, more particularly, to a method and apparatus for updating an image with improved greyscale accuracy.

Recent technological advances have provided “user friendly” electronic reading devices such as e-books that open up many opportunities. For example, electrophoretic displays hold much promise. Such displays have an intrinsic memory behavior and are able to hold an image for a relatively long time without power consumption. Such a display is a representative example of a bi-stable display. Power is consumed only when the display needs to be refreshed or updated with new information. So, the power consumption in such displays is very low, suitable for applications for portable e-reading devices like e-books and e-newspaper. Electrophoresis refers to movement of charged particles in an applied electric field. When electrophoresis occurs in a liquid, the particles move with a velocity determined primarily by the viscous drag experienced by the particles, their charge (either permanent or induced), the dielectric properties of the liquid, and the magnitude of the applied field. An electrophoretic display is a type of bi-stable display, which is a display that substantially holds an image without consuming power after an image update.

For example, international patent application WO 99/53373, published Apr. 9, 1999, by E Ink Corporation, Cambridge, Mass., US, and entitled Full Color Reflective Display With Multichromatic Sub-Pixels, describes such a display device. WO 99/53373 discusses an electronic ink display having two substrates. One is transparent, and the other is provided with electrodes arranged in rows and columns. A display element or pixel is associated with an intersection of a row electrode and column electrode. The display element is coupled to the column electrode using a thin film transistor (TFT), the gate of which is coupled to the row electrode. This arrangement of display elements, TFT transistors, and row and column electrodes together forms an active matrix. Furthermore, the display element comprises a pixel electrode. A row driver selects a row of display elements, and a column or source driver supplies a data signal to the selected row of display elements via the column electrodes and the TFT transistors. The data signals correspond to graphic data to be displayed, such as text or figures.

The electronic ink is provided between the pixel electrode and a common electrode on the transparent substrate. The electronic ink comprises multiple microcapsules of about 10 to 50 microns in diameter. In one approach, each microcapsule has positively charged white particles and negatively charged black particles suspended in a liquid carrier medium or fluid. When a positive voltage is applied to the pixel electrode, the white particles move to a side of the microcapsule directed to the transparent substrate and a viewer will see a white display element. At the same time, the black particles move to the pixel electrode at the opposite side of the microcapsule where they are hidden from the viewer. By applying a negative voltage to the pixel electrode, the black particles move to the common electrode at the side of the microcapsule directed to the transparent substrate and the display element appears dark to the viewer. At the same time, the white particles move to the pixel electrode at the opposite side of the microcapsule where they are hidden from the viewer. When the voltage is removed, the display device remains in the acquired state and thus exhibits a bi-stable character. In another approach, particles are provided in a dyed liquid. For example, black particles may be provided in a white liquid, or white particles may be provided in a black liquid. Or, other colored particles may be provided in different colored liquids, e.g., white particles in green liquid.

Other fluids such as air may also be used in the medium in which the charged black and white particles move around in an electric field (e.g., Bridgestone SID2003—Symposium on Information Displays. May 18-23, 2003,—digest 20.3). Colored particles may also be used.

To form an electronic display, the electronic ink may be printed onto a sheet of plastic film that is laminated to a layer of circuitry. The circuitry forms a pattern of pixels that can then be controlled by a display driver. Since the microcapsules are suspended in a liquid carrier medium, they can be printed using existing screen-printing processes onto virtually any surface, including glass, plastic, fabric and even paper. Moreover, the use of flexible sheets allows the design of electronic reading devices that approximate the appearance of a conventional book.

However, further developments are needed to achieve an accurate greyscale with minimized visibility and reduced image update time.

In a particular embodiment, a method for updating an image on a bi-stable display by driving at least a portion of the display from a current optical state to a final optical state, includes driving the at least a portion of the display from the current optical state to a reference optical state, wherein the reference optical state is selected based on the current optical state, and driving the at least a portion of the display from the reference optical state to the final optical state.

In another embodiment, a method is provided for updating an image on a bi-stable display by driving at least a portion of the display from a current optical state to a final, extreme state. For transitions wherein the current optical state and the final, monochrome optical state differ, the method includes driving the at least a portion of the display from the current optical state to the final, extreme state by applying an extreme driving pulse with a duration that is proportional to a distance that particles in the bi-stable display must move to transition from the current optical state to the final, extreme state. For transitions wherein the current optical state and the final, extreme state are the same, the method includes leaving the at least a portion of the display unaddressed.

A related electronic reading device and program storage device are also provided.

Within the concept of the invention, an “optical state” or the like is to be broadly interpreted as any visual condition or situation, including a visual condition between, or at, extreme states. This can include a visual condition between a first extreme state (e.g., white or black or a particular color) and a second extreme state (e.g., black or white or another particular color). For example, the optical state may be a greyscale state on a scale between two extreme states such as black and white. Or, the optical state may be a greyscale state between, or at, two extreme color states such as white and blue. Or, the optical state may be an intermediate state between, or at, three extreme states, such as red, green and blue. For simplicity, in the description below, a black and white display is primarily used to illustrate the invention.

Moreover, a pre-set pulse or the like refers to a voltage pulse representing energy, determined by pulse time×pulse voltage level, that is sufficient to release particles at one of the extreme states, but insufficient to move the particles from one of the extreme states to the other. A pre-set pulse can be a positive or negative voltage pulse that transitions from a reference voltage such as zero voltage to a positive or negative voltage value, respectively, and back to zero. Moreover, a shaking pulse may comprise a number of pre-set pulses that alternate between positive and negative voltages. A reset pulse refers to a voltage pulse representing energy sufficient to move particles from the present position or state to one of the extreme positions or states, which is generally not the final desired state. For example, in a black and white display, a reset pulse is able to move the particles from the present state to the black state or white state. A standard reset pulse may be augmented by an additional reset pulse, or over-reset pulse, to ensure the image quality. The term over-reset pulse may refer to a reset pulse having a standard duration and an over-reset duration. An extreme drive pulse refers to a voltage pulse representing energy sufficient to move particles from the present position or state to a final state, which is one of the extreme states. An extreme drive pulse can be used with, or in place of, a reset pulse. Moreover, the extreme drive pulse can have a duration that is sufficient, or more than sufficient, to move particles from the present state to the final, extreme state. Thus, the extreme drive pulse duration is analogous to the reset or over-reset pulse duration.

In the drawings:

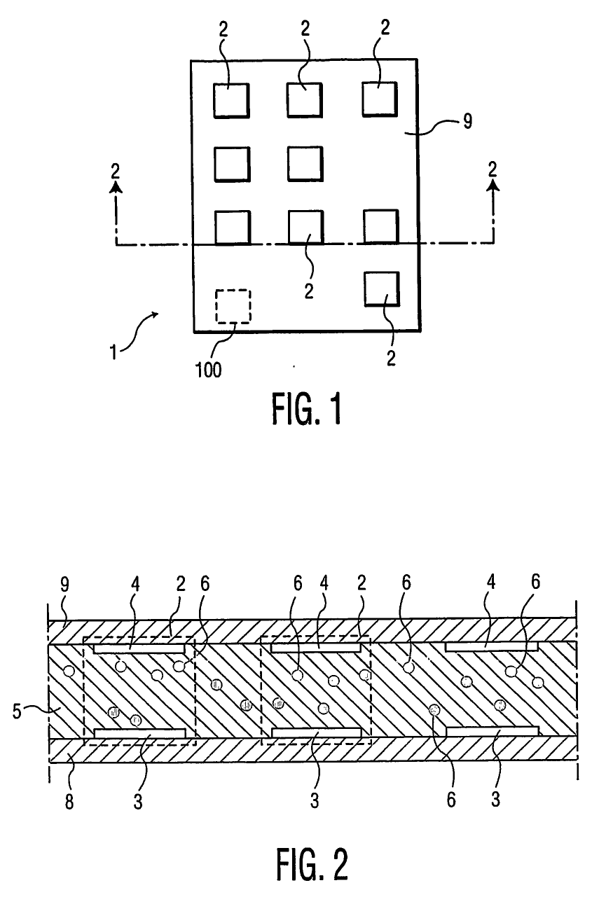

FIG. 1 shows diagramatically a front view of an embodiment of a portion of a display screen of an electronic reading device;

FIG. 2 shows diagramatically a cross-sectional view along 2-2 in FIG. 1;

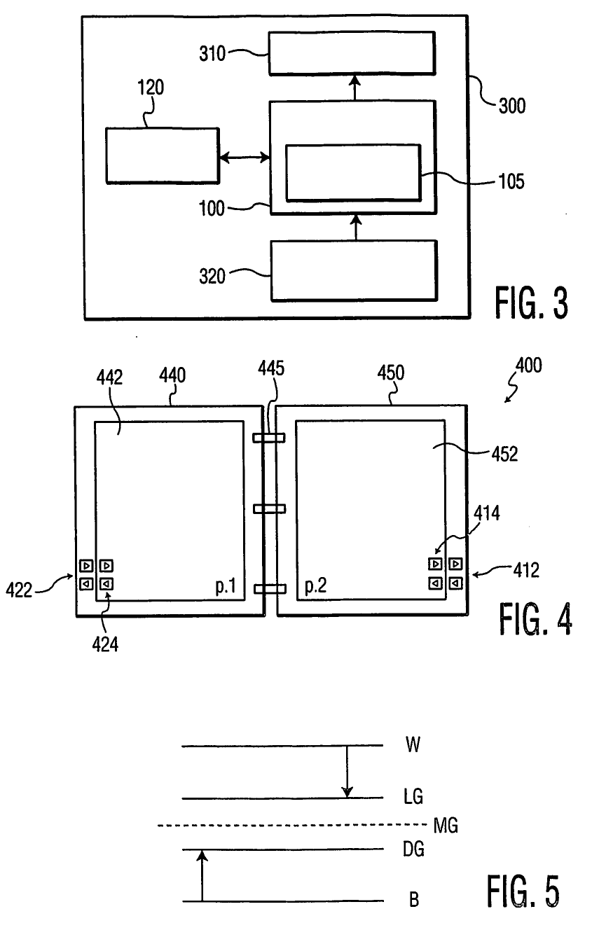

FIG. 3 shows diagramatically an overview of an electronic reading device;

FIG. 4 shows diagramatically two display screens with respective display regions;

FIG. 5 illustrates a driving scheme where the reference optical state is chosen based on the final optical state;

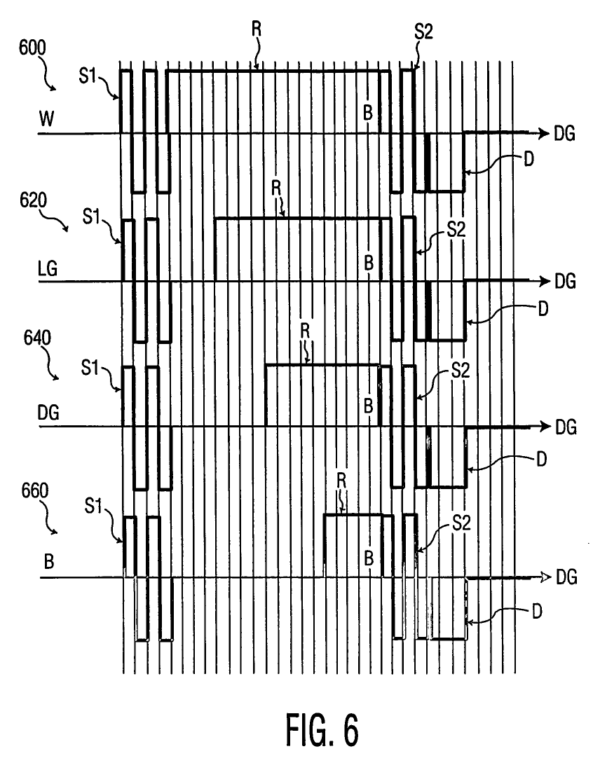

FIG. 6 illustrates representative driving waveforms based on the principle of FIG. 5 for greyscale transitions to dark grey (DG);

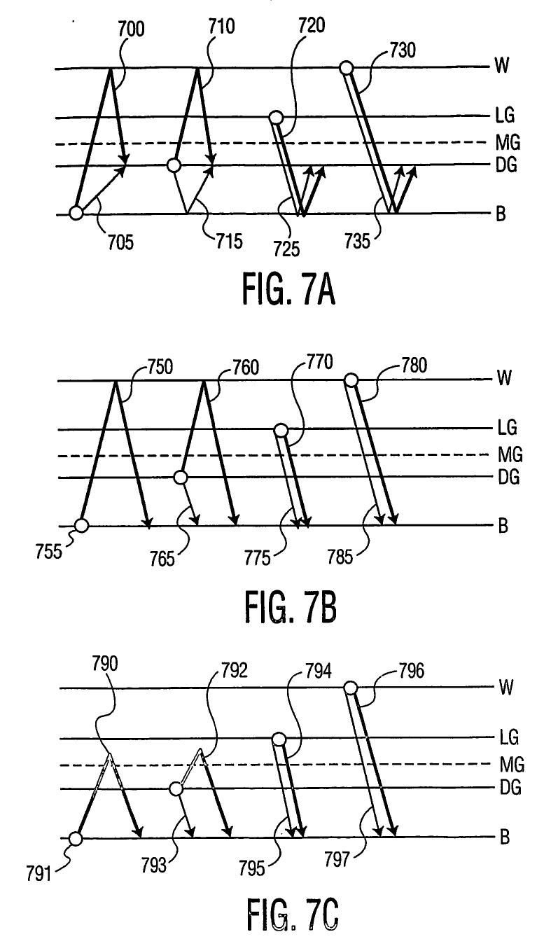

FIG. 7a illustrates driving schemes for optical transitions to dark grey (DG), comparing transitions where the reference optical state is chosen based on the final optical state to transitions where, according to this invention, the reference optical state is chosen based on the current optical state;

FIG. 7b illustrates a driving scheme for optical transitions to black (B), comparing transitions where the reference optical state is chosen based on the final optical state to transitions where, according to this invention, the reference optical state is chosen based on the current optical state;

FIG. 7c illustrates driving schemes for optical transitions to black (B), comparing transitions where the reference optical level is chosen based on the final optical level to transitions where, according to this invention, the reference optical level is chosen based on the current optical level, and where the particles only need to cross the middle point (MG) for transitions from B and DG to B;

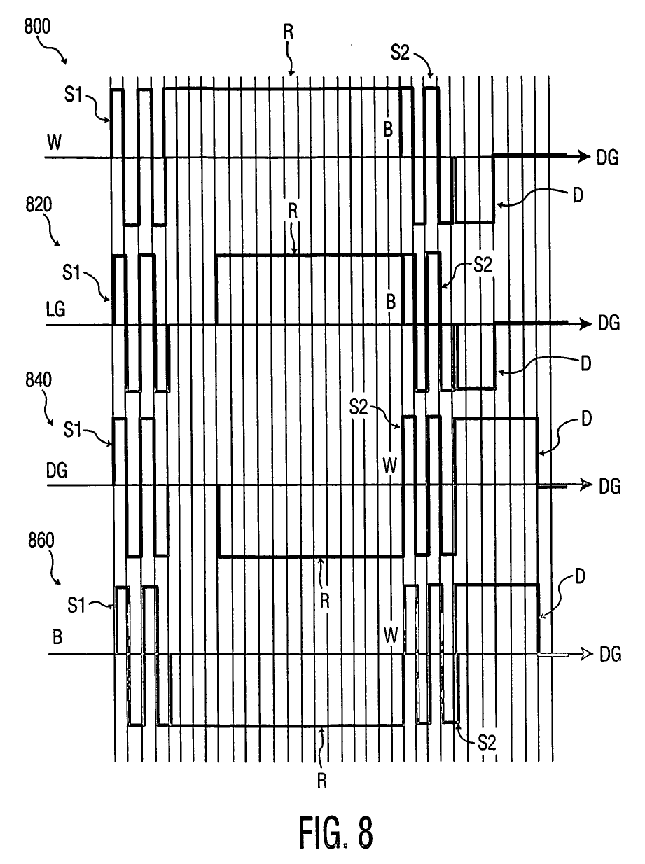

FIG. 8 illustrates representative driving waveforms based on the principle of FIG. 7a for optical transitions to dark grey (DG), where the reference optical state is chosen based on the current optical state;

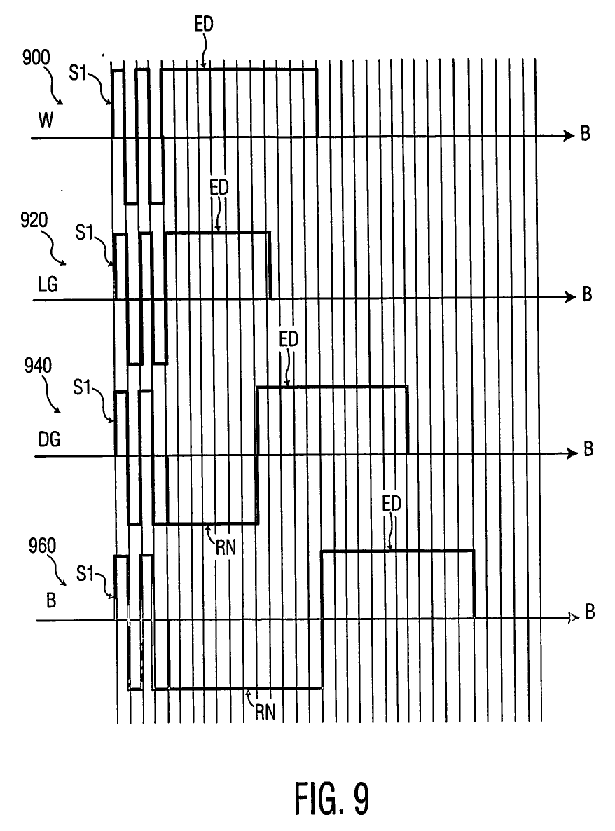

FIG. 9 illustrates representative driving waveforms based on the principle of FIG. 7b for image transitions to an extreme state e.g. black (B), where the reference optical state is chosen based on the current optical state, according to this invention;

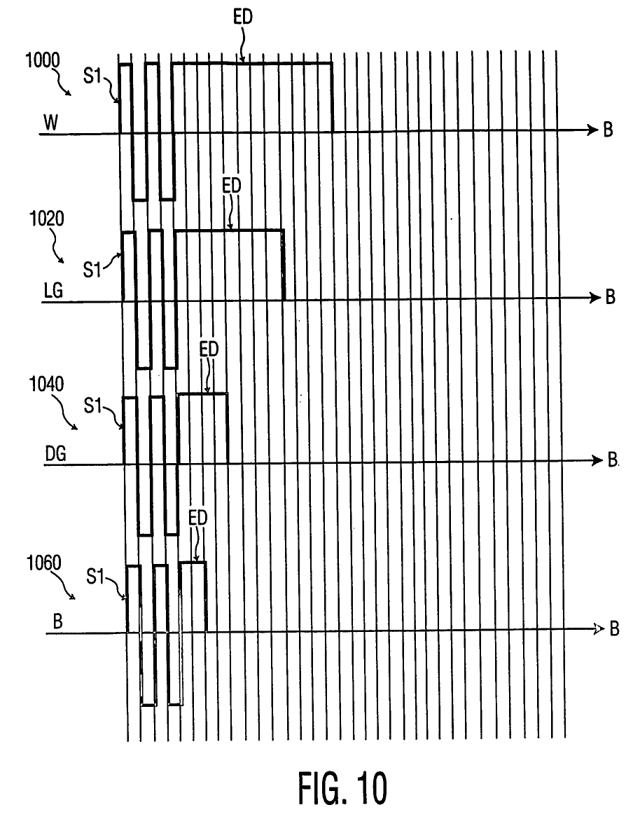

FIG. 10 illustrates representative driving waveforms for image transitions to an extreme state, e.g. black (B), where a single reset pulse is applied in all transition, according to this invention;

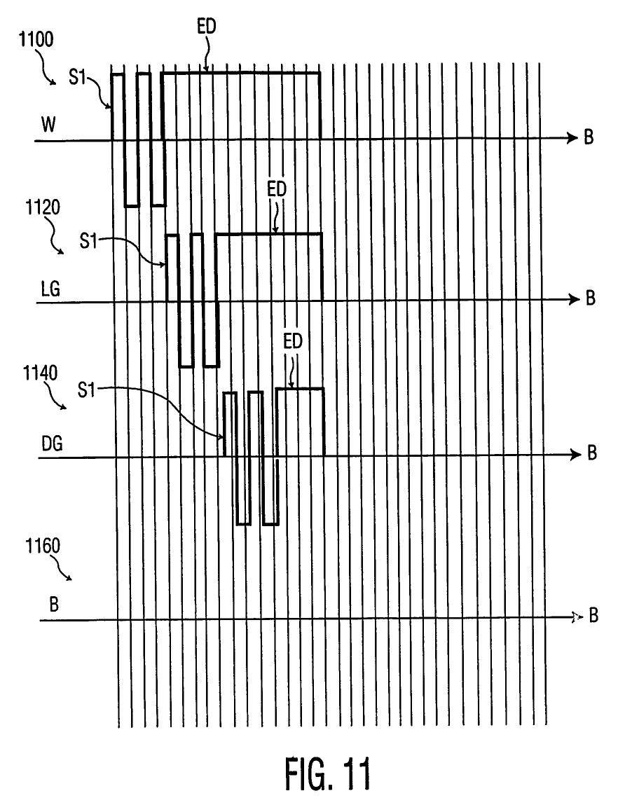

FIG. 11 illustrates representative driving waveforms for image transitions to an extreme state e.g. black (B), where a single reset pulse is applied in all transitions except for same-state transitions, according to this invention; and

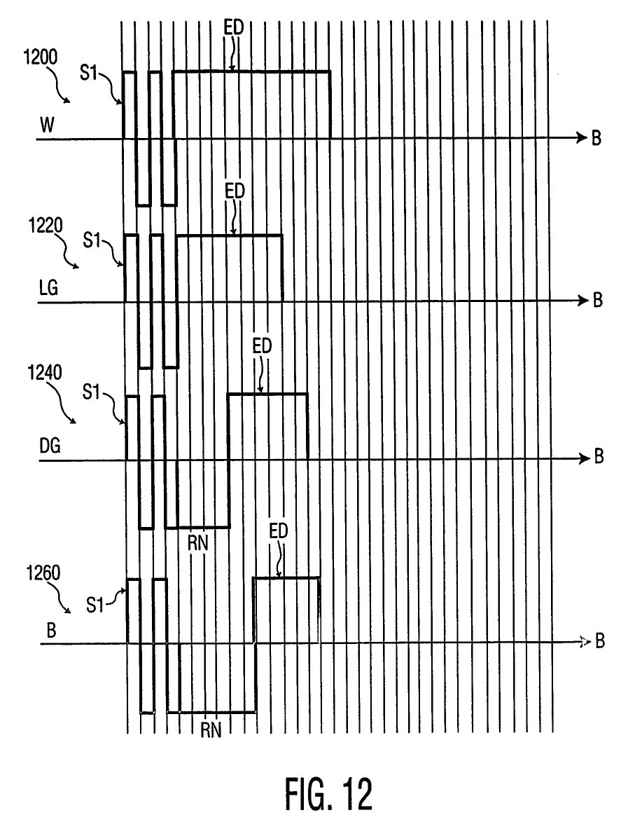

FIG. 12 illustrates representative driving waveforms for image transitions to an extreme state, e.g., black (B), which are derived from those of FIG. 9 and based on the principle of FIG. 7c, but with a reduced flicker/flashing visibility, according to this invention.

In all the Figures, corresponding parts are referenced by the same reference numerals.

FIGS. 1 and 2 show the embodiment of a portion of a display panel 1 of an electronic reading device having a first substrate 8, a second opposed substrate 9 and a plurality of picture elements 2. The picture elements 2 may be arranged along substantially straight lines in a two-dimensional structure. The picture elements 2 are shown spaced apart from one another for clarity, but in practice, the picture elements 2 are very close to one another so as to form a continuous image. Moreover, only a portion of a full display screen is shown. Other arrangements of the picture elements are possible, such as a honeycomb arrangement. An electrophoretic medium 5 having charged particles 6 is present between the substrates 8 and 9. A first electrode 3 and second electrode 4 are associated with each picture element 2. The electrodes 3 and 4 are able to receive a potential difference. In FIG. 2, for each picture element 2, the first substrate has a first electrode 3 and the second substrate 9 has a second electrode 4. The charged particles 6 are able to occupy positions near either of the electrodes 3 and 4 or intermediate to them. Each picture element 2 has an appearance determined by the position of the charged particles 6 between the electrodes 3 and 4. Electrophoretic media 5 are known per se, e.g., from U.S. Pat. Nos. 5,961,804, 6,120,839, and 6,130,774 and can be obtained, for instance, from E Ink Corporation.

As an example, the electrophoretic medium 5 may contain negatively charged black particles 6 in a white fluid. When the charged particles 6 are near the first electrode 3 due to a potential difference of, e.g., +15 Volts, the appearance of the picture elements 2 is white. When the charged particles 6 are near the second electrode 4 due to a potential difference of opposite polarity, e.g., −15 Volts, the appearance of the picture elements 2 is black. When the charged particles 6 are between the electrodes 3 and 4, the picture element has an intermediate appearance such as a grey level between black and white. A drive control 100 controls the potential difference of each picture element 2 to create a desired picture, e.g., images and/or text, in a full display screen. The full display screen is made up of numerous picture elements that correspond to pixels in a display.

FIG. 3 shows diagramatically an overview of an electronic reading device. The electronic reading device 300 includes the control 100, including an addressing circuit 105. The control 100 controls the one or more display screens 310, such as electrophoretic screens, to cause desired text or images to be displayed. For example, the control 100 may provide voltage waveforms to the different pixels in the display screen 310. The addressing circuit provides information for addressing specific pixels, such as row and column, to cause the desired image or text to be displayed. As described further below, the control 100 causes successive pages to be displayed starting on different rows and/or columns. The image or text data may be stored in a memory 120. One example is the Philips Electronics small form factor optical (SFFO) disk system. The control 100 may be responsive to a user-activated software or hardware button 320 that initiates a user command such as a next page command or previous page command.

The control 100 may be part of a computer that executes any type of computer code devices, such as software, firmware, micro code or the like, to achieve the functionality described herein. Moreover, the memory 120 is a program storage device that tangibly embodies a program of instructions executable by a machine such as the control 100 or a computer to perform a method that achieves the functionality described herein. Such a program storage device may be provided in a manner apparent to those skilled in the art.

Accordingly, a computer program product comprising such computer code devices may be provided in a manner apparent to those skilled in the art. The control 100 may have logic for periodically providing a forced reset of a display region of an electronic book, e.g., after every x pages are displayed, after every y minutes, e.g., ten minutes, when the electronic reading device is first turned on, and/or when the brightness deviation is larger than a value such as 3% reflection. For automatic resets, an acceptable frequency can be determined empirically based on the lowest frequency that results in acceptable image quality. Also, the reset can be initiated manually by the user via a function button or other interface device, e.g., when the user starts to read the electronic reading device, or when the image quality drops to an unacceptable level.

The invention may be used with any type of electronic reading device. FIG. 4 illustrates one possible example of an electronic reading device 400 having two separate display screens. Specifically, a first display region 442 is provided on a first screen 440, and a second display region 452 is provided on a second screen 450. The screens 440 and 450 may be connected by a binding 445 that allows the screens to be folded flat against each other, or opened up and laid flat on a surface. This arrangement is desirable since it closely replicates the experience of reading a conventional book.

Various user interface devices may be provided to allow the user to initiate page forward, page backward commands and the like. For example, the first region 442 may include on-screen buttons 424 that can be activated using a mouse or other pointing device, a touch activation, PDA pen, or other known technique, to navigate among the pages of the electronic reading device. In addition to page forward and page backward commands, a capability may be provided to scroll up or down in the same page. Hardware buttons 422 may be provided alternatively, or additionally, to allow the user to provide page forward and page backward commands. The second region 452 may also include on-screen buttons 414 and/or hardware buttons 412. Note that the frame 405 around the first and second display regions 442, 452 is not required as the display regions may be frameless. Other interfaces, such as a voice command interface, may be used as well. Note that the buttons 412, 414; 422, 424 are not required for both display regions. That is, a single set of page forward and page backward buttons may be provided. Or, a single button or other device, such as a rocker switch, may be actuated to provide both page forward and page backward commands. A function button or other interface device can also be provided to allow the user to manually initiate a reset.

In other possible designs, an electronic book has a single display screen with a single display region that displays one page at a time. Or, a single display screen may be partitioned into or two or more display regions arranged, e.g., horizontally or vertically. In any case, the invention can be used with each display region to reduce image retention effects and to improve the smoothness of the image update.

Furthermore, when multiple display regions are used, successive pages can be displayed in any desired order. For example, in FIG. 4, a first page can be displayed on the display region 442, while a second page is displayed on the display region 452. When the user requests to view the next page, a third page may be displayed in the first display region 442 in place of the first page while the second page remains displayed in the second display region 452. Similarly, a fourth page may be displayed in the second display region 452, and so forth. In another approach, when the user requests to view the next page, both display regions are updated so that the third page is displayed in the first display region 442 in place of the first page, and the fourth page is displayed in the second display region 452 in place of the second page. When a single display region is used, a first page may be displayed, then a second page overwrites the first page, and so forth, when the user enters a next page command. The process can work in reverse for page back commands. Moreover, the process is equally applicable to languages in which text is read from right to left, such as Hebrew, as well as to languages such as Chinese in which text is read column-wise rather than row-wise. It is also possible to have a single display screen that is partitioned into two or more separate display regions.

Additionally, note that the entire page need not be displayed on the display region. A portion of the page may be displayed and a scrolling capability provided to allow the user to scroll up, down, left or right to read other portions of the page. A magnification and reduction capability may be provided to allow the user to change the size of the text or images. This may be desirable for users with reduced vision, for example.

Driving Scheme

To provide a robust driving method for an electrophoretic display or other bi-stable display, a reference state during an optical transition is chosen according to the current optical state, independent of the final optical state to be displayed. In one approach, where the optical state is defined by a greyscale having at least two-bits, e.g., four states or greyscale levels, when the current optical state is between full dark or black (0%) and middle grey (50% grey), the reference white state is chosen, from where the display is driven to the desired grey level. When the current optical state is between full white (100%) and middle grey (50% grey), the reference black state is chosen. With this approach, only a single polarity reset pulse is required, either to the reference white or reference black state. Moreover, one or more pre-pulses may be used prior to the reset pulse and/or greyscale driving voltage pulse. One or more shaking pulses may also be used. Either the reset pulse or the greyscale driving pulse, or both pulses, will cause particles to cross the middle point—middle grey—during any single image transition. In this way, greyscale accuracy is improved with relatively low power consumption.

Optical states such as greyscales in electrophoretic displays are generally created by applying voltage pulses to pixels in the display for specified time periods. They are strongly influenced by factors such as image history, dwell time, temperature, humidity, lateral inhomogeneity of the electrophoretic foils, etc. Accurate grey levels can be achieved using a rail-stabilized approach in which the grey levels are always achieved either from the two extreme optical states or rails, e.g., the reference black or reference white state. For further information, refer to European patent application no. 02079203.2, filed Oct. 10, 2002 (docket no. PHNL021000), incorporated herein by reference. According to this European patent application, the reference rail state for a greyscale transition is chosen according to the final desired grey level, as schematically shown in FIG. 5.

FIG. 5 illustrates the driving method of the above-mentioned European patent application. In this example, the display has four optical states: white (W), light grey (LG), dark grey (DG) and black (B). For a greyscale transition to LG, the display is first reset to the full white state and then driven to the LG state. For a greyscale transition to DG, the display is first reset to the full black state and then driven to the DG state. In particular, the grey levels between full white (100% bright) and middle grey (MG) (50% grey) are achieved by driving the pixel or other portion of the display from the reference white state. The grey levels between full dark (0%) and middle grey (50%) are achieved by driving the pixel from the reference black state. The advantage of this approach is that it achieves an accurate greyscale with minimized visibility and reduced image update time. Based on this principle, a driving scheme using an over-reset voltage pulse has been found to be most promising for driving an electrophoretic display. For further information, refer to European patent application no. 03100133.2, filed Jan. 23, 2003 (docket no. PHNL030091), incorporated herein by reference. The pulse sequence usually includes four portions: at least one first shaking pulse (S1), a reset pulse (R), at least one second shaking pulse (S2) and a greyscale driving pulse (D). This method is schematically shown in FIG. 6 for image transitions to DG from W (waveform 600), LG (waveform 620), DG (waveform 640), and B (waveform 660).

FIG. 6 illustrates representative driving waveforms based on the principle of European patent application no. 02079203.2 for greyscale transitions to DG using a reset pulse consisting of both a “standard” reset pulse and an over-reset pulse for resetting the display to the closest rail (i.e., B) of the greyscale. The four transitions to DG from W, LG, DG and B are realized using four types of pulse sequences that include an over-reset for resetting the display. The duration of the reset pulse (R) is relatively longer for the transitions from W or LG to DG and relatively shorter for the transitions from DG or B to DG. A disadvantage of this method is that we often find a relatively broad distribution of the brightness of the DG level, which particularly originates from the relative short transition sequences from DG or B to DG.

Proposed Solution

Here, we propose an improved driving method for an electrophoretic display where a reference state during an optical transition is chosen according to the current optical state, independent of the final optical state to be achieved. In particular, when the current optical state is between full dark (0%) and middle grey (50% grey), the reference white state is chosen from where the display is driven to the desired grey level. When the current optical state is between full white (100%) and middle grey (50% grey), the reference black state is chosen. Only a single polarity reset pulse is required either to the reference white or reference black state. One or more short pre-pulses or shaking pulses are used prior to and/or after the reset pulse and/or greyscale driving voltage pulse. Either the reset pulse or the greyscale driving pulse, or both pulses, will cause particles to cross the middle point—middle grey—between the electrodes in the display during any image transition. In this way, greyscale accuracy is improved with relatively low power consumption because in each single image transition, the image history is erased when the particles cross the middle point. Moreover, an additional pulse is not needed as requested in other driving schemes. This saves additional power.

A driving method according to this invention is schematically shown in FIG. 7a for transitions to dark grey, and in FIG. 7b and 7c for transitions to black. FIG. 7a illustrates driving schemes for optical transitions to dark grey (DG), comparing transitions where the reference optical state is chosen based on the final optical state to transitions where, according to this invention, the reference optical state is chosen based on the current optical state. Again, in this example, the display has four optical states: white (W), light grey (LG), dark grey (DG) and black (B). However, the invention may be adapted for use with other greyscales as well, e.g., a three-bit greyscale having eight states, a four-bit greyscale having sixteen states, and so forth. The invention can be extended to color displays as well. The reference state to be reset during an optical transition is chosen according to the current optical state, independent of the final optical state to be displayed. When the current state is between B and MG, the display is reset to the full white state. Otherwise, e.g., when the current state is between W and MG, the display is reset to the full black state. Essentially, the reference state is selected as a rail or extreme state that is visually furthest from the current optical state. Specifically, with the approach of the invention, the transitions from B, DG, LG and W to DG are given by paths 700, 710, 720 and 730, respectively. For comparison, with the approach of European patent application no. 02079203.2, the transitions from B, DG, LG and W to DG are given by paths 705, 715, 725 and 735, respectively. Transitions to LG are analogous and may be pictured by changing the optical states in FIG. 7a from W, LG, DG and B to B, DG, LG and W, respectively.

Thus, for transitions to DG from B or DG, the display is first reset to W as the reference state from where the display is then directly driven to DG. In contrast, for the transitions to DG from LG or W, the display is first reset to B as the reference state from where the display is then directly driven to DG. In this way, particles are forced to cross the middle grey position at least once in each single image transition in all types of transitions, resulting in a narrow distribution of the grey level for the particles even though the previous states, or history, of the particles differ. The approach of the invention is superior to other approaches such as those in which a bi-polar reset pulse is used in short transitions to mix the particles. In such cases, after the mixing pulse, the display is reset to the closest rail during a greyscale transition, and the greyscale accuracy increases with an increase in the pulse time for the mixing pulse. However, a shock effect/sudden image change may be observed which becomes stronger as the mixing pulse time increases. Also, the use of a bi-polar reset pulse may consume more power. The approach of the invention reduces the shock effect/sudden image change while also reducing power consumption since a change of the voltage polarity in the reset portion during a greyscale transition is not needed.

A similar approach may be used for transitions to the extreme optical states, e.g., B or W. For example, transitions to B are shown in FIG. 7b. FIG. 7b illustrates a driving scheme for transitions to black (B), comparing transitions where the reference optical state is chosen based on the final optical state to transitions where, according to this invention, the reference optical state is chosen based on the current optical state. Specifically, with the approach of the invention, the transitions from B, DG, LG and W to B are given by paths 750, 760, 770 and 780, respectively. Thus, the display is driven from the current optical state to the final optical state so that there is a crossing of the midpoint of the greyscale or color spectrum. With the approach of European patent application no. 02079203.2, the transitions from B, DG, LG and W to B are given by paths 755, 765, 775 and 785, respectively. The path 755 actually involves no transition to other states since the particles remain in the black state. Transitions to W are analogous and may be pictured by changing the optical states in FIG. 7b from W, LG, DG and B to B, DG, LG and W, respectively.

An alternative approach, which can further reduce flicker, may be used for transitions to the extreme optical states, e.g., black or white. For example, transitions to black are shown in FIG. 7c. FIG. 7c illustrates driving schemes for transitions to black (B), comparing transitions where the reference optical state is chosen based on the final optical state to transitions where, according to this invention, the reference optical state is chosen based on the current optical state, and where the particles only need to cross the middle point (MG) for transitions from B and DG to B. Specifically, with the approach of the invention, the transitions from B, DG, LG and W to B are given by paths 790, 792, 794 and 796, respectively. With the approach of European patent application no. 02079203.2, the transitions from B, DG, LG and W to B are given by paths 791, 793, 795 and 797, respectively. The path 791 involves no transition to other states since the particles remain in the black state. In this approach, the particles only need to cross the middle point (MG) and then reset to the correct final desired rail state for the transitions from B and DG to B. Transitions to W are analogous and may be pictured by changing the greyscale states in FIG. 7c from W, LG, DG and B to B, DG, LG and W, respectively.

Implementation for Greyscale Image Transitions

The driving waveform of FIG. 6 can be adjusted as shown in FIG. 8. FIG. 8 illustrates representative driving waveforms based on the principle of FIG. 7a for transitions to dark grey (DG), where the reference optical state is chosen based on the current optical state. Greyscale transitions are provided to DG from W (waveform 800), LG (waveform 820), DG (waveform 840) and B (waveform 860), using a reset pulse (R) for resetting the display to one of the two extreme optical states or rails (B or W) depending on the current state. Namely, if the current state is W or LG, the display is reset to B, and if the current state is DG or B, the display is reset to W. In particular, for transitions to DG from W or LG (waveforms 800 and 820), a positive reset pulse (R) is applied to send the display to the full black state, after which a negative drive pulse (D) is used for driving the display to the desired DG state. For transitions to DG from B or DG (waveforms 840 and 860), a negative reset pulse (R) is applied to send the display to the full white state, after which a positive drive pulse (D) is used for driving the display to DG.

Prior to the reset pulse (R) and the driving pulse (D), shaking pulses (S1, S2) are applied to the display. Now, the DG is realized from the reference white state. However, the DG is realized still via the closest rail B when the current state is LG or W. The situation for transitions to LG is similar to that for transitions to DG. LG is realized from the reference black state when the current state is W or LG, and when the current state is B or DG, the LG is realized still via the closest rail, W. In this way, the greyscale accuracy is not limited anymore by the short transitions because of the crossing of the middle point in each single image transition. Note that the reset pulse (R) includes both a “standard” reset pulse and an additional, over-reset pulse. The standard reset pulse duration is proportional to the distance that the particles in the display need to move from one electrode to another. The over-reset pulse duration is chosen so that the image retention is minimized. In this example, for simplicity, a constant over-reset time is chosen in all waveforms.

Implementation for Image Transitions Towards the Extreme Optical States (I)

The final optical state in an image transition may be an extreme optical state, e.g., an optical state at an extreme end of the color or greyscale range. For example, a monochrome transition is a transition to the extreme states of B or W. FIG. 9 illustrates representative driving waveforms based on the principle of FIG. 7b for image transitions to an extreme state, e.g. black (B), where the reference optical state is chosen based on the current optical state. In particular, representative waveforms according to the invention based on the principle of FIG. 7b are schematically shown in FIG. 9 for monochrome transitions to B from W (waveform 900), LG (waveform 920), DG (waveform 940) and B (waveform 960). An extreme drive pulse (ED) is used for driving the display to one of the two rails or extreme state (B or W) depending on the current state: from W/LG, the display is directly reset to B, and from DG/B, the display is reset to W, then back to B. Thus, the display is driven from the current optical state to the final optical state so that there is a crossing of the midpoint of the greyscale or color spectrum, as discussed with FIG. 7c. If the current and final optical states are on the same end of the spectrum, such as for the DG to B and B to B transitions, the final optical state is realized by applying the reset pulse (RN) followed by the ED pulse of opposite polarity to at least a portion of the display at least until the final optical state is reached. If the current and final optical states are on different ends of the spectrum, such as for the W to B and LG to B transitions, the final optical state is realized by applying the extreme drive pulse (ED) to the at least a portion of the display until the final optical state is reached.

As mentioned, an extreme drive pulse refers to a voltage pulse representing energy sufficient to move particles from the present position or state to a final state, which is one of the extreme states. For the transitions to the extreme state B from B or DG, a negative reset pulse (RN) is applied to send the display to the full white state, after which a positive extreme drive pulse (ED) is used for driving the display back to the desired B state.

Prior to the reset pulse, at least one pre-set pulse is applied to the display. In FIGS. 9-12, at least one pre-set pulse or shaking pulse (S1) may be applied to the display before and/or after the RN and ED pulses, or the ED pulse when used alone. In particular, hardware and/or software shaking pulses may be applied prior to the extreme driving pulse (ED), when it is used. In contrast to software shaking pulses, which are applied to each pixel depending on the pixel data, hardware shaking pulses are applied to the whole display panel independent of the pixel data. The B state is realized via the opposite rail, W, for transitions from DG or B, while the B state is directly realized for transitions from LG or W. However, realizing the final state via the opposite rail can lead to increased visibility.

Implementation for Image Transitions Towards the Extreme Optical States (II)

According to the invention, to reduce the image update visibility and the total image update time of the above embodiment, waveforms may be used as shown in FIG. 10 for the same transitions as in FIG. 9. FIG. 10 illustrates representative driving waveforms for image transitions to an extreme state, e.g. black (B), where a single extreme driving pulse (ED) is applied in all transition. In particular, waveforms are shown for monochrome transitions to B from W (waveform 1000), LG (waveform 1020), DG (waveform 1040) and B (waveform 1060). Here, only a single extreme driving pulse (ED) is applied in all transitions for resetting the display to B. The extreme driving pulse (ED) has a duration that is proportional to the distance that the particles need to move between two electrodes in the display, with the addition of the relatively small duration beyond that. It has been experimentally observed that, with this approach, the accuracy of the extreme or rail optical states is often sufficiently accurate, and is less sensitive to the image history. Moreover, although the electrophoretic display is bi-stable, and therefore tends to hold its current state, a black-to-black pulse is needed to account for drift or fade and keep the image black when the at least one pre-set pulse or hardware shaking pulse (S1) is applied. An analogous pulse may be needed for a white-to-white transition.

Implementation for Image Transitions Towards the Extreme Optical States (III)

The waveforms of FIG. 10 can be further simplified as shown in FIG. 11. FIG. 11 illustrates representative driving waveforms for image transitions to an extreme state e.g. black (B), where a single extreme driving pulse (ED) is applied in all transitions except for same-state transitions, e.g., B to B. In particular, waveforms are shown for monochrome transitions to B from W (waveform 1100), which is the same as waveform 10000 from FIG. 10, from LG (waveform 1120), from DG (waveform 1140) and from B (waveform 1160). For same color or state transitions, e.g., black-to-black (waveform 1160) or white-to-white, it is not necessary to address the display because of the bi-stable/image stable character of electrophoretic displays. The display is thus unaddressed for such transitions. That is, the same level of optical state is not updated. This reduces power consumption. For transitions where the display is addressed (e.g., waveforms 1100, 1120 and 1140), the timing of the at least one pre-set pulse or, if used, shaking pulse (S1), and extreme driving pulse (ED) may be set so that the extreme driving pulses (ED) terminate concurrently for the different transitions to improve the visual effect perceived by the user.

Implementation for Image Transitions Towards the Extreme Optical States (IV)

An alternative approach as illustrated in FIG. 7c was discussed previously. Representative waveforms according to the invention based on the principle of FIG. 7c are schematically shown in FIG. 12 for monochrome transitions to B from W (waveform 1200), LG (waveform 1220), DG (waveform 1240) and B (waveform 1260). An extreme drive pulse (ED) is used for resetting the display to the middle point. For the transitions to B from B or DG, a relatively short negative reset pulse (RN) is applied to send the display, or portions of the display such as at least one pixel, to just crossing the middle point, e.g. MG, after which a positive ED pulse is used for “driving” the display back to the desired B state. The positive ED pulse thus acts as a drive pulse. Prior to the reset pulse (RN) or ED pulse, at least one pre-set pulse, or shaking pulse (S1), if used, are applied to the display. Additional shaking pulses may be supplied prior to the ED pulse when used. For transitions to B from B or DG, the B state is realized via the middle point. The B state is directly realized when the current state is LG or W. The fact that the B state is realized via the middle point can lead to decreased visibility of the update and increased greyscale accuracy.

Note that the invention is not limited to any particular driving concept or concepts, but can be used in any scheme with rail-stabilized driving. Moreover, the invention may be implemented in passive matrix as well as active matrix electrophoretic displays. In fact, the invention can be implemented in any bi-stable display that does not consume power while the image substantially remains on the display after an image update. Also, the invention is applicable to both single and multiple window displays, where, for example, a typewriter mode exists. Furthermore, note that, in the above examples, pulse-width modulated (PWM) driving is used for illustrating the invention, i.e., the pulse time is varied in each waveform while the voltage amplitude is kept constant. However, the invention is also applicable to other driving schemes, e.g., based on voltage modulated driving (VM), where the pulse voltage amplitude is varied in each waveform, or combined PWM and VM driving. This invention is also applicable to color bi-stable displays. Also, the electrode structure is not limited. For example, a top/bottom electrode structure, honeycomb structure or other combined in-plane-switching and vertical switching may be used.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A method for updating an image on a bi-stable display by driving at least a portion of the display from a current optical state to a final optical state, the method comprising:
driving the at least a portion of the display from the current optical state to a reference optical state;
wherein the reference optical state is selected based on the current optical state; and
driving the at least a portion of the display from the reference optical state to the final optical state.

2. The method of claim 1, wherein:
the bi-stable display comprises an electrophoretic display.

3. The method of claim 1, wherein:
the reference optical state is selected as an extreme optical state that is furthest from the current optical state.

4. The method of claim 1, wherein:
the current optical state, reference optical state, and final optical state are greyscale optical states.

5. The method of claim 4, wherein:
the reference optical state is selected as the white state when the current optical state is between full black and middle grey; and
the reference optical state is selected as the black state when the current optical state is between full white and middle grey.

6. The method of claim 1, wherein:
at least one of the current optical state, reference optical state, and final optical state is a color optical state.

7. The method of claim 1, wherein:
the reference optical state is selected independently of the final optical state.

8. The method of claim 1, wherein:
the reference optical state is selected as a middle point for image transitions towards an extreme black state as the final optical state when the current optical state is between full black and middle grey; and
the reference optical state is selected as the middle point for image transitions towards an extreme white state as the final optical state when the current optical state is between full white and middle grey.

9. The method of claim 1, wherein:
the driving of the at least a portion of the display from the current optical state to the reference optical state comprises applying a reset pulse to the at least a portion of the display; and
the driving of the at least a portion of the display from the reference optical state to the final optical state comprises applying, to the at least a portion of the display, an extreme driving pulse following the reset pulse and of opposite polarity.

10. The method of claim 9, wherein:
the driving of the at least a portion of the display from the current optical state to the final optical state comprises applying at least one pre-set pulse to the at least a portion of the display prior to and/or after the reset pulse.

11. The method of claim 9, wherein:
the applying at least one pre-set pulse comprises applying a single pre-set pulse having a polarity opposite to that of the reset pulse.

12. The method of claim 9, wherein:
the reset pulse comprises an over-reset pulse.

13. The method of claim 1, wherein:
when the current optical state and the final optical state are on the same end of a spectrum, the driving of the at least a portion of the display from the current optical state to the final optical state comprises applying a reset pulse (RN) to the at least a portion of the display followed by an extreme drive pulse (ED) of opposite polarity at least until the final optical state is reached; and
when the current optical state and the final optical state are on different ends of the spectrum, the driving of the at least a portion of the display from the current optical state to the final optical state comprises applying a reset pulse (RN) to the at least a portion of the display at least until the final optical state is reached.

14. The method of claim 13, wherein:
the driving of the at least a portion of the display from the current optical state to the final optical state comprises applying at least one pre-set pulse to the at least a portion of the display prior to and/or after the reset pulse (RN).

15. The method of claim 14, wherein:
the applying at least one pre-set pulse comprises applying a single pre-set pulse having a polarity opposite to that of the extreme driving pulse.

16. A program storage device tangibly embodying a program of instructions executable by a machine to perform a method for updating an image on a bi-stable display by driving at least a portion of the display from a current optical state to a final optical state, the method comprising:
driving the at least a portion of the display from the current optical state to a reference optical state;
wherein the reference optical state is selected based on the current optical state; and
driving the at least a portion of the display from the reference optical state to the final optical state.

17. An electronic reading device, comprising:
a bi-stable display (310, 400); and
a control (100) for updating an image on the bi-stable display by driving at least a portion of the display from a current optical state to a final optical state, the control comprising:
means for driving the at least a portion of the display from the current optical state to a reference optical state;
wherein the reference optical state is selected based on the current optical state; and
means for driving the at least a portion of the display from the reference optical state to the final optical state.

18. A method for updating an image on a bi-stable display by driving at least a portion of the display from a current optical state to a final, extreme optical state, the method comprising:
for transitions wherein the current optical state and the final, extreme optical state differ, driving the at least a portion of the display from the current optical state to the final, extreme optical state comprises applying an extreme driving pulse (ED) with a duration that is proportional to a distance that particles in the bi-stable display must move to transition from the current optical state to the final, extreme optical state; and
for transitions wherein the current optical state and the final, extreme optical state are the same, leaving the at least a portion of the display unaddressed.

19. The method of claim 18, further comprising:
applying at least one pre-set pulse to the at least a portion of the display prior to and/or after the extreme driving pulse.

20. The method of claim 19, wherein:
the applying at least one pre-set pulse comprises applying a single pre-set pulse having a polarity opposite to that of the extreme driving pulse.
